(19) United States
(12) Patent Application Publication
(10) Pub. No.: US 2009/0149234 A1
(43) Pub. Date: Jun. 11, 2009

(54) Managing Participation in a series of Matches in a Real Time Trivia Match

(75) Inventor: Andrew S. Van Luchene, Santa Fe, NM (US)

Correspondence Address: GONZALES PATENT SERVICES, 4605 CONGRESS AVE. NW, ALBUQUERQUE, NM, 87114, US

(73) Assignee: LEVIATHAN ENTERTAINMENT, Santa Fe, NM (US)

(21) Appl. No.: 11/951,990

(22) Filed: Dec. 6, 2007

(51) Int. Cl. A63F 9/24; A63F 13/12

(52) U.S. Cl. 463/9; 463/42

(57) ABSTRACT

The present disclosure provides a trivia game in which a contestant selected from a group of participants is able to create a trivia question and then posit a putative answer to the question. The participants can then vote as to whether or not the putative answer is correct or incorrect. Participants may be rated in order to determine eligibility and access to various aspects of the game.

### BACKGROUND

Trivia games are a popular pastime worldwide across a wide variety of media including television and the internet. New forms of trivia games, particularly those that take advantage of the internet in order to allow for a large number of participants, are desirable.

### DETAILED DESCRIPTION

According to one embodiment, the present disclosure provides a broadcast trivia match that allows questioning contestants to create questions and an associated set of multiple choice answers. Questioning contestants also select the correct answer from the multiple choice options as the “correct” answer. The answer flagged by the questioning contestant as correct can be false. Answering contestants can select an answer from the multiple choice answers. The central system notifies the contestants and the audience whether or not the answer selected was the correct answer as designated by the questioning contestant. If the selected answer was not a correct answer, the answering contestant can challenge answer. The audience is able to vote on whether the “correct” answer indicated by the questioning contestant is true or false. The average vote of the audience determines whether the “correct” answer is true or false. Members of the audience who are on the majority side of the vote receive a reward that is taken from the questioning contestant or answering contestant based on whether or not the “correct” answer was true or false.

In an alternate embodiment snippets of digital content can be attached to a question as proof and can be used to determine the correct answer of a question in the event of a challenge.

For purposes of the present disclosure:

Audience—includes a group of end users who have access to observe a trivia match and who can vote on the correctness of selected answers and correct answers to trivia questions provided in the trivia match.

Audience Member—includes an end user who is a member of the audience

Audience Member Vote—includes a vote placed by or on behalf of an audience member, in which the vote relates to the correctness of a selected answer and/or relates to a correct answer of a trivia match

Reward—includes a virtual benefit given to an audience member in exchange for voting, voting correctly, voting with the majority or any other voting activity.

Contestant—includes an end user who participates in a trivia match

Online Match—includes a trivia match provided through a website. The audience can log in to the match on the website and place votes directly into the web interface.

Televised Match—includes a trivia match that can be viewed on tv. Votes for televised matches can be placed via cell phones or devices installed in the studio set of the trivia game.

Cell Phone Match—includes a trivia match that can be played or viewed on a cell phone or other portable electronic device

Portable Electronic device includes a device such as a cell phone, blackberry, handheld computer, laptop computer or other device which is in communication or able to communicate with other electronic devices whether the communication is wireless or wired.

Trivia Question—includes a question and two or more corresponding answers with one of the answers being flagged as a correct answer

Trivia Answer—includes an answer to a trivia question

Questioning Contestant—includes a contestant who is asking a question

Answering Contestant—includes a contestant who is answering a question

Correct Answer—includes an answer flagged by the questioning contestant as the correct answer to a trivia question

Selected Answer—includes an answer selected by or on behalf of the answering contestant in response to a trivia question

Practice Match—includes a trivia match that can be played where no rewards or penalties are available to any of the end user participants

Practice contestant—includes an end user who is a contestant of a practice match

Practice audience member—includes an end user who is an audience member of a practice match

Practice audience—includes a group of two or more end users is participate in a practice trivia match as the audience.

Trivia Match—includes an online or televised game where at least two end users participate as contestants and at least two end users participate as audience members.

Broadcast—includes a manner of making available, e.g., via the Internet or televised or otherwise

Trivia Match Round—includes at least one question being asked by a questioning contestant and being answered by a answering contestant.

Virtual credit—includes an amount of virtual currency in an end user account or available to an end user account

Virtual Credit Wager—includes a wager amount denominated in virtual currency that can be placed, e.g., by a questioning contestant when asking a question, and answering contestant when answering a question or challenging a correct answer, or a audience member when placing a vote.

Question Challenge—includes a challenge of the correct answer by an answering contestant that can occur when his selected answer does not match the correct answer

Qualification Survey—includes a survey submitted by an end user that is used to generate an end user type for the player

End User Type—includes a setting of an end user that allows that end user to participate in trivia matches as an audience member or contestant

Contestant Teams—includes groups of two more contestants who participate as a team

Team Match—includes a trivia match where contestants compete in teams of two or more

End User Expertise—includes a score given to end users for specific types of trivia that is used to qualify and allow the end user to participate as an audience member or contestant in or a series of trivia matches.

Trivia Match Series—includes a series of trivia matches that an end user is registered to participate in.

End User—includes any person who is able to participate in a trivia match as an audience member or contestant

Vote Session—includes a period of time when audience members can place votes for a challenged question

Vote Fee amount—includes a fee that audience members pay in order to place votes

Team Winner—includes a group of contestants who participate as a team in a trivia match and win.

Team member—includes a contestant who participates in a team

Substitute—includes an end user that is selected to replace a team member who does not show up for a trivia match

Trivia Match Series—includes a series of matches that one or more contestants agree to play.

Proof—a snippet of digital content that can be used to prove that a correct answer is not false.

Video—a snippet of digital content that is in video format which can be used as a proof

Compilation—a group of two or more snippets of video and or clips. Video can be television shows, movies, or user generated videos. A compilation can be an Avatar Skin.

Clip—a snippet of digital content that is video sound or any other data.

Avatar Skin includes the outside appearance of an avatar embedded in a virtual world

Skin includes the outside appearance of a virtual object in a virtual environment

According to an exemplary embodiment, two contestants compete against each other in rounds of trivia about a certain group of Star Trek episodes. In each round of the match contestants create questions that they ask to the other contestant. Along with providing the question, the contestant also indicates an amount of virtual credit he is willing to wager on the question. The question created by the first contestant is asked to the second contestant, who selects an answer (the “selected answer”) from the multiple choice answers included in the question. The system determines if the selected answer is the correct answer provided. If the selected answer is not the same as the correct answer, the second contestant is provided with the option to challenge the correct answer. If the second contestant challenges the question, he provides a wager amount that he posts with the challenge. The audience then enters their votes about whether or not the correct question is true or false. The average vote determines whether the correct question is true or false. If the correct answer is true, then the wager of the second contestant is divided up amongst the audience who voted that the question was true. If the question was false, then the wager of the first contestant is divided up amongst the audience who voted that the question was false. Once the first contestant has completed a round of question asking to a second contestant, the second contestant can then ask a question to the first contestant in a similar manner.

According to some embodiments, players must serve as a member of the voting audience a certain number of times, or they must submit a certain number of correct votes before they can become a contestant

According to various embodiments, contestants can be selected randomly from an audience group. End Users log in to a central server, for example, to be an audience for a match about a particular trivia category. The system randomly picks contestants from the logged in end users and makes the rest of the end users the audience. Rules can be applied to create a pool of end users from which to randomly select contestants. Exemplary rules may include factors such as:
1. the number of times an end user has been a contestant
2. the number of times an end user has been an audience member
3. the status of the end user
4. the number of times an end user has won a trivia match
5. the number of times the user has not been selected to be a contestant before

It will be appreciated that there may be a variety of rules identified to govern how the game is played. According to one embodiment, the game may employ one or more of the following rules:

A challenged correct answer can be given a fixed time limit within which to receive votes from the audience about the answer.

When a question is challenged, an advertisement can be triggered for the time limit specified before the votes have been tallied. Advertisements can be targeted based on the trivia category and end user device viewing the advertisement.

A challenge may not be able to be considered fulfilled unless a certain minimum number of votes are received from the audience.

When one contestant challenges another contestant, their wager is placed in escrow and not released until the round of play is complete and the reward winner is determined.

The audience members and the contestants can pay or be paid to participate in a trivia match. If the system determines contestants from a group of end users, it can pay one or more end users who were not selected to be contestants to be audience members.

According to some embodiments, the game may include team matches. Teams may be assembled using any means. In one particular embodiment, teams can be randomly assembled based on trivia category expertise. End users indicate that they want to participate in a match about a particular trivia category. In a group match, multiple trivia categories are played at the same time by teams, each with corresponding experts for each trivia category. The system selects experts for each category from the pool of end users logged in for the match.

According to various embodiments, a reward can be divided evenly amongst all voters, or winning voters could each receive a fixed or minimum reward.

Alternatively, rather than the contestants wagering an amount of virtual currency along with their question, the system can determine the reward available for successfully answering a trivia question in each round of play. Contestants can receive a virtual reward for answering questions correctly, or asking questions that were not answered correctly.

It will be appreciated that the game may employ one or more types of rewards. Exemplary rewards may include one or more reward type including, but not limited to:
1. Virtual currency
2. Virtual goods (a virtual home or product)
3. Virtual rights (access to certain areas of a virtual world)
4. Real or virtual service credits (free phone time)
5. A virtual persona or virtual avatar modification

According to various embodiments, rewards may be distributed for a variety of different behaviors. For example, a reward can be given to an audience member for:
1. Viewing the match
2. Voting on a question
3. Voting with the majority on a question
4. Participating as an audience member
5. Viewing advertisements embedded in the match

In some embodiments, rewards per vote given can be displayed to encourage more voting by voters.

According to one or more embodiments, rewards are automatically transferred from one end user account to another based on play results.

According to various embodiments, audience members can wager a virtual reward on their votes. If the vote turns out to be the majority vote, the audience member wins the wager. The winning amount can be based on a variety of factors including, but not limited to:
1. the wager
2. the member wagering
3. the number of total votes
4. the percent of votes that are the winning vote
5. the number of votes that are the winning vote

According to various embodiments, a random set of audience votes can be selected so that the audience cannot collude with one contestant or another contestant.

In some embodiments, a voting audience can be selected from a viewing audience based on rules and conditions such as:
1. whether or not an audience member is an expert in a trivia category
2. whether or not an audience member has been a voting member in previous matches
3. whether or not an audience member has been flagged as a colluding member (i.e. the voted too much in favor of a participating contestant in previous matches.
4. whether or not an audience member has downloaded and viewed content relevant to the trivia match
5. whether or not an audience member has won rounds of the trivia match in the trivia category as a contestant or a practice contestant.

According to various embodiments, votes received can be tallied and displayed in real time to encourage other voters to participate.

In one or more embodiments, a contestant can list an amount he is willing to pay for votes from the audience. He can post this amount before the challenge is put to vote and can adjust this amount based on how the vote is going. Audience members who vote in favor of the contestant receive the posted benefit when they place the vote or the max benefit offered by the contestant during the challenge. A contestant may only be able to pay for votes in an amount that is not greater than the virtual credit he has available. For example if he has 200 credits and there are 20 members of an audience, he can only pay 10 credits per vote and not more.

According to some embodiments, audience members who vote with the majority a certain number of times, a certain number of times in a row, or in any other progression can receive incrementally greater rewards based on the measurement of their increased participation.

In one or more embodiments, audience members who vote in the minority can be charged a fine that is paid to the audience members who vote in the majority.

According to an embodiment, an end user can only be an audience member if they are an expert in the trivia category being covered in the match.

According to some embodiments, the game may employ a trivia match series. In this embodiment, winning contestants or winning teams can be automatically registered as contestants for later matches. Challengers can be randomly picked to compete against the individual or team.

According to an embodiment, when a team member does not show up for a match, a new team member can be picked from the end users logged in to play. The previous rewards won by the team member while he participated on the team can be taken away from that team member and given to the new team member.

According to various embodiments, a contestant is required to compete in a series of trivia matches either individually or as a member of a team. The system generates a set of trivia matches based on the expertise of the contestant and the team that he is a member of. The end user agrees to participate in the whole series (maybe pays or is paid to do so) and also agrees to pay a penalty if he does not show up for one or more of the matches in the specified series. The match series can also be output in a format so that they can be loaded into a third party calendar program such as Microsoft Outlook (Microsoft Corporation, Redmond, Wash.).

According to various embodiments, the game may be created as part of or in order to foster a community based on a shared interest of the audience and participants. For example, trivia matches can be based on content that can be viewed (e.g., on television) or downloaded (e.g., from the Internet) (reruns) A show schedule can be created along with a trivia match schedule that corresponds to the show schedule. End users interested in being an audience or contestant for a particular trivia match can download a show schedule into outlook or another calendar program. End users may receive alerts via email and/or cell phone and/or other means.

In some embodiments, contestants and audience members may have access to a database such as a wiki (e.g. Wikipedia) or other online or offline information repository that they can use to research the answer to a question before submitting a selected answer or vote. End Users may require a certain status to have access to such a service and/or may be limited to the number of times or what matches they are able to use the access.

In some embodiments, Contestants and Audience Members may have access to a real time chat session where friends and family can give advice about the answer to a question during a trivia match, trivia round, or trivia challenge. End Users may require a certain status to have access to such a service and/or may be limited to the number of times or what matches they are able to use the access.

According to various embodiments, instead of contestants creating questions in real time, the audience or other end users can create questions and include proofs for the answers of their questions. The system creates and posts match times for specified content and makes that content available for creating questions. End users create questions for the content specified and are able to attach video clips from the content to create proofs for the correct answer they specify.

As a non-limiting example, an end user logs in to the system and selects content for which he would like to create questions. The system outputs the content and stores questions created by the end users along with video clips from the content that are stored as proofs. The questions are stored and made available for trivia matches during the appropriate specified match times.

Exemplary types of user-created questions include, but are not limited to:
1. Questions for videos (e.g., “in 24, who killed Jack Bauer's wife?”)
2. Multiple choice answers to the questions with a specified correct answer
3. “proof”—a “compilation” video which demonstrates the answer to a question (e.g., a 90 second video clip showing the Nina Myers killing Jack Bauer's wife)
4. “entry”—a factual piece of information about a video clip, much like an entry in wikipedia or IMDB. (e.g., episode synopsis, title, season, character list, events occurred, cameos). Can also be a factual piece of information about characters or other things besides a video clip itself (e.g., a character description such as “Mr. Spock is half human”)
5. “dialog”—the text of the dialog for a specified portion of video (e.g., the text for the first minute of an episode)
6. “naming” an episode—a user-defined name, e.g., “the season 1 finale”, which can make searching more productive

According to various embodiments, limitations can be put on the question. Exemplary limitations may include, but are not necessarily limited to:
1. how long the clip is that can be used for the proof
2. how many clips can be used for the proof
3. whether or not the clip has been used for a proof before can prevent a question from being created that uses that clip as proof again (could be a certain n times that a given clip can be used as a proof in a question

According to various embodiments, users may create video compilations that are used in various aspects of the game. In an embodiment, once the compilation is created, the compilation can be stored only on the central game server so users need not (or cannot) have a local copy of copyrighted content.

In some embodiments, a compilation may be defined by one or more “clips” appended together. Each “clip” is specified by a video, a start time in that video and a stop time in that video (e.g., “video 12345, 1:04, 2:27” specifies a clip that starts at 1 minute 4 seconds in video 12345, and ends two minutes twenty seven seconds into that video). Since the user specifies how to create the compilation from video content, but does not himself have access to, alter or control that video content, copyright owners are more comfortable allowing such derivative works to be created.

Accordingly, once a compilation is created, it is stored (e.g. on the server) and may be made available to the community. Furthermore, the copyright owner or another party may be able to review compilations and modify or remove them.

In some embodiments, a compilation can be created from one or more other compilations.

Creation of compilations may be governed by various rules. For example, a user can have a maximum number of clips he can create.

In some embodiments, the system can be set up with log in and other test software to ensure that only end users and not bots are downloading clips and creating content.

According to one or more embodiments, it may be desirable to prevent or limit the number of duplicate compilations in the system. Accordingly, the system may be configured to detect whether or not clips that are created by end users have already been used in compilations completed by other end users. Furthermore, the system may limit the number of times particular content can be used to create compilations or proofs.

Since, as explained above, compilations may be defined by time portions of a video, a computer can easily determine whether portions of a video have compilations created for them and which don't. For example, if there are many compilations with time ranges in the first few minutes, but none in the second hour, then the computer can detect this and direct that it would be desirable for the community to create some questions, compilations, etc. for the second hour of the video. The system can also give a score for the level of difficulty of a question based on the clip that is used as proof for the question. A clip that is not as used (or downloaded, or viewed) gives a higher difficulty score to questions that are asked that use the clip as proof.

In some embodiments, the content owner can specify that his content (e.g., video clips) is:
1. View only—or—
2. Can be used to create compilations

Where a video is designated as usable to create compilations, then the content owner can further specify which other videos may be combined with his video. For example, videos that are “combinable” with the originally created compilation may be limited to:
1. compilations only made from the video itself (e.g., a compilation is made from single episode)
2. compilations made with any other episodes in the series (e.g., from any Star Trek episode), or within a season in the series (e.g., can make compilations from any season except the current season)
3. compilations made with any other videos owned by a certain owner (e.g., by Paramount, by NBC)

In some embodiments, a compilation can be the skin of an avatar of an end user. The end user can cut the skin out of content (i.e. cut captain kirk out of a clip of star trek and apply the compilation to the end user avatar to create a custom skin for the avatar. In addition to creating skins for avatars, skins can be created for any type of virtual property (homes, offices, furniture, etc) in a virtual world. End Users can earn the right to use content to create skins or can pay for the privilege to do so.

In another embodiment, the system may be configured to make an entire avatar or other virtual item, including the skeleton, from an object or person that appears in the video clip. For example, if a film clip displays a television set, the television set shown in the video could then be rendered into a virtual space. Furthermore, sounds can be taken from the clip and used to create synthetic voice, noise, ambiance, or other sound-related files. Still further, an end user may own the right to render a given virtual space, object, person, etc. from a video clip.

In some embodiments, the system allows questions to be created using a markup language, referred to herein as an entertainment markup language (EML), where end users can specify the content, and its hierarchy (e.g., studio, series, season, episode)

The EML can specify metadata like the data available on IMDB—actors, directors, release date, dialog, as well as game-specific information such as whether or not an audience member has downloaded and viewed content relevant to the trivia match

According to yet another embodiment, contestants can create a series of questions with corresponding proofs that they can ask during a match.

The end user may have the ability to fake a proof by editing the clip in such a way as to make it prove something different than what it actually was. In this embodiment, fake correct answers can be provided along with fake proofs. A contestant can challenge a correct answer and its proof, and the clip can be viewed in full to determine if the clip was faked. Alternatively, the contestant can challenge the proof, and the audience can vote on whether or not the proof was faked. In some embodiments, the audience can submit new proofs along with their vote to challenge a proof provided with a question and correct answer. In other embodiments the answering contestant can submit a counter proof with his challenge and the audience can vote on which contestant they believe is right.

In embodiments where questions are not written in real time by contestants, the system or an administrator can pick questions to ask during matches based on a variety of factors. Exemplary factors include, but are not limited to, 1) the specified trivia covered in a match 2) the level of difficulty of a particular question that is available.

The level of difficulty of a particular question can be determined by any number of suitable factors. Exemplary difficulty level determiners may be: 1) the system based on the video footage used to create the proof (i.e. video that has been used the fewest times to create proof for a question is scored as more difficult than footage that has been used to create proofs for a number of questions; 2) the end user who created the question and the correct answer rate of those questions that were previously asked in matches; 3) an administrator; 4) the audience who votes on which questions to ask. Audience votes can happen in real time or before matches.

The system could output a group of available questions to ask and one or more members of the audience could vote on which question to ask during any given round of a trivia match.

To avoid fraud and or collusion, the system can provide questions to contestants based on rules such as:
1. randomly picking questions from a group
2. only picking questions from certain audience members
3. not asking questions from end users where a contestant has already answered questions provided by that end user in past matches
4. allowing some or all the audience to vote on which questions to ask in real time.

In some embodiments, an audience member can pay or be paid to ask a question with a corresponding proof. In some embodiments, the audience member who pays the post to have his question asked will have his question asked first. If a contestant cannot answer the question correctly, the audience member can be paid a reward. If a contestant can answer the question correctly, the audience member can be fined.

According to some embodiments, the game may employ user-ratings. Users can be rated according to various criteria. Exemplary, but not limiting, rating criteria include:
1. Scores,
2. Games played,
3. Games won,
4. Contributions made (e.g., generated questions and/or answers)
5. User ratings can be used to make various determinations. For example, a user rating can determine, in whole or in part:
6. Access to certain content (e.g., video, answers, questions)
7. Access to certain games
8. Inclusion as a contestant, or as a type of contestant
9. Access to certain game results

According to some embodiments, user can pay or be paid when others use their questions, compilations, etc. Similarly, user can be paid for submitting videos, entries, etc.

In an embodiment, the payment for submitting a certain type of question or compilation goes to the first user who posts it (if it meets quality constraints). This creates a race to submit complete content. Duplicate compilations can be detected by threshold similarities of the clips they are made up of. In some embodiments, if users pay to view videos, they can get credit for submitting questions, entries, answering questions, etc.

According to various embodiments, pages with videos can include links to a sales engine to purchase DVDs (e.g., of the viewed series, of related series, etc.) Moreover, pages with videos can include links to sales engine to purchase online video/rights to online video (in an embodiment where you can pay to watch on the computer)

According to yet another embodiment, the presently-described game and system may include a copyright clearing house. It will be appreciated that frequently the Video Data provided for compilations and trivia matches may have one or more copyright holders or revenue sharers (“revenue recipients”) including, for example, writers, actors, studios, etc. The disclosed system may be configured to track various types of usage of the video clips that are related to usage for revenue distribution. This may include, but is not limited to:
1. How many times a video is viewed
2. How many times a video snippet is used for a compilation
3. How many times a video snippet is used for a proof
4. How many times a video snippet is used for a question
5. How many times a video snippet is used in a question that is asked during a match

For each video snippet, there may be a database of revenue recipients along with corresponding royalty payment percentages to be paid to each revenue recipient when a snippet is used. At the end of each billing cycle, the system compiles usage of video snippets and determines payment due to revenue recipients based on usage and payment percentages. A pool of capital is divided up and distributed to revenue recipients on a periodic basis based on snippet usage.

Those having skill in the art will recognize that there is little distinction between hardware and software implementations. The use of hardware or software is generally a choice of convenience or design based on the relative importance of speed, accuracy, flexibility and predictability. There are therefore various vehicles by which processes and/or systems described herein can be effected (e.g., hardware, software, and/or firmware) and that the preferred vehicle will vary with the context in which the technologies are deployed.

At least a portion of the devices and/or processes described herein can be integrated into a data processing system with a reasonable amount of experimentation. Those having skill in the art will recognize that a typical data processing system generally includes one or more of a system unit housing, a video display device, memory, processors, operating systems, drivers, graphical user interfaces, and application programs, interaction devices such as a touch pad or screen, and/or control systems including feedback loops and control motors. A typical data processing system may be implemented utilizing any suitable commercially available components to create the gaming environment described herein.

Accordingly, the presently described system may comprise a plurality of various hardware and/or software components such as those described below. It will be appreciated that for ease of description, the variously described hardware and software components are described and named according to various functions that it is contemplated may be performed by one or more software or hardware components within the system. However, it will be understood that the system may incorporate any number of programs configured to perform any number of functions including, but in no way limited to those described below. Furthermore, it should be understood that while, for ease of description, multiple programs and multiple databases are described, the various functions and/or databases may, in fact, be part of a single program or multiple programs running in one or more locations.

Exemplary Programs which may or may not be hosted on a central server, include:
a. Trivia Match Program
b. End User Qualification Program
c. Question and Proof Creation Program
d. Advertisement generation program
e. Audience Voting Program
f. Skin Creation Program

Exemplary databases, which also may or may not be hosted on a central server include:

End User Database which may associate or have access to data such as:
a. ID
b. Type
c. Expertise
d. Personal Info
e. Billing Info
f. Survey Profile
g. Advertisement 1-n
h. Access to wikipedia during matches
i. Access to wikipedia during challenges
j. Access to chat session during matches
k. Access to chat session during challenges
l. Wikipedia usage limitations
m. Chat usage limitations

Trivia Match Database which may associate or have access to data such as:
a. ID
b. Start Date
c. End Date
d. Trivia Type 1-n
e. Contestants 1-n
   1. Teams 1-n
f. Audience Members 1-n
g. Questions 1-n
h. Challenges 1-n
i. Votes 1-n
j. Advertisement 1-n

Trivia Type Database which may associate or have access to data such as:
a. ID
b. Descriptor
c. Data (tv shows, scripts, books, etc)
d. Advertisement 1-n

Audience Member Database which may associate or have access to data such as:
a. Trivia Match ID
b. End User ID
c. Challenges 1-n
d. Votes 1-n
e. Advertisement 1-n

Challenge Database which may associate or have access to data such as:
a. Challenge ID
b. Question ID
c. Trivia Match ID
d. Contestant ID 1-n
e. Audience Member ID 1-n
f. Result
g. Reward
h. Advertisement 1-n

Vote Database which may associate or have access to data such as:
a. Vote ID
b. Challenge ID
c. Question ID
d. Correct Answer
e. Selected Answer
f. Audience Member ID 1-n
g. Vote 1-n
h. Wager 1-n
i. Fee 1-n
j. Reward 1-n

Contestant Database which may associate or have access to data such as:
a. Trivia Match ID
b. End User ID
c. Questions 1-n
d. Challenges 1-n
e. Advertisement 1-n

Question Database which may associate or have access to data such as:
a. ID
b. Question
c. Answer 1-n
d. Correct Answer
e. Selected Answer
f. Challenge
g. Vote
h. Compilation 1-n
i. Proof 1-n

Reward Database which may associate or have access to data such as:
a. ID
b. Type
c. Amount
d. Reward rules and conditions

Team Database which may associate or have access to data such as:
a. End User ID 1-n
b. Expertise 1-n
c. Match 1-n
d. Advertisement 1-n

Virtual Property Database which may associate or have access to data such as:
a. ID
b. Descriptor
c. Value
d. Owner

Advertisement Database which may associate or have access to data such as:
a. ID
b. Applicable rules and conditions 1-n
c. Match 1-n
d. Challenge 1-n
e. End User 1-n

Ad rules and conditions database which may associate or have access to data such as:
a. ID
b. Descriptor

Survey Database which may associate or have access to data such as:
a. Question 1-n
b. Answer 1-n

Wikipedia Database which may associate or have access to data such as:
a. ID
b. Topic
c. Type
d. Data
e. Date

Chat Session Database which may associate or have access to data such as:
a. ID
b. Data
c. Date
d. Event

Chat Availability and Usage Rules and Conditions which may associate or have access to data such as:
a. ID
b. Event type
c. Event
d. End user type
e. End user 1-n
f. Rule
g. Condition

Wikipedia Availability and Usage Rules and Conditions which may associate or have access to data such as:
a. ID
b. Event type
c. Event
d. End user type
e. End user 1-n
f. Rule
g. Condition

Content Database which may associate or have access to data such as:
a. Content ID
b. Owner ID 1-n
c. Content Data
d. Usage Rules and Conditions
e. Royalty Rules and Conditions

Content Owner Database which may associate or have access to data such as:
a. Owner ID
b. Owner Personal Info
c. Owner Billing Info
d. Owner Type 1-n
e. Royalty fee 1-n

Content Fee Database which may associate or have access to data such as:
a. Content ID
b. Content Type
c. Content Use 1-n
d. Content Fee 1-n
e. Content Use rules and conditions

Content Use Database which may associate or have access to data such as:
a. Content ID
b. Date Used
c. Use Type
d. Fee

Compilation Database which may associate or have access to data such as:
a. Compilation ID
b. Compilation Creator ID
c. Content 1-n
d. Compilation Data 1-n

Proof (video compilation database) which may associate or have access to data such as:
a. Proof ID
b. Proof Type
c. Compilation ID 1-n
d. Proof Creator ID

Compilation rules and conditions which may associate or have access to data such as:
a. ID
b. Descriptor
c. Type 1-n

Question Scoring Rules and Conditions which may associate or have access to data such as:
a. ID
b. Descriptor
c. Type 1-n

Audience Voting Rules and Conditions which may associate or have access to data such as:
a. ID
b. Descriptor
c. Type 1-n

Virtual skin database which may associate or have access to data such as:
a. ID
b. Type
c. Compilation ID
d. Clip ID 1-n
e. End User ID
f. Usage Rules and Restrictions
g. Skin Fees 1-n
h. Skin Royalties 1-n

It will be appreciated that the various software and hardware components described above will be configured to perform a variety of functions and methods. Listed below are some exemplary methods that might be performed by the systems as described herein:

Qualify to participate in a trivia match
a. Receive a request to participate in a trivia match
b. Output a qualification survey
c. Receive survey response
d. Qualify end user based on responses
e. Generate an end user type
f. Allow end user to participate in trivia matches based on type
g. Alternate (or ongoing after first qualification)
h. Receive qualification activity from an end user (take a test to see how much you know)
i. Receive trivia match activity from an end user (as a contestant or audience member)
j. Generate an end user type based on activity
k. Allow user to participate in trivia matches based on type

Provide and Answer Question
a. Output a question form to a questioning contestant
b. Receive a question including at least two answers with one of the answers being flagged as the correct answer and a wager amount
c. Output question and answers to answering contestant
d. Receive a selected answer from the answering contestant and a wager amount
e. Determine if selected answer matches correct answer
f. If answers match, provide reward to answering contestant
g. If answers do not match output “incorrect answer” message
h. Receive request to challenge answer from answering contestant including a wager amount
i. Output question to audience for audience vote
j. Receive an audience vote
k. Determine if questioning contestant or answering contestant won vote
l. Apply reward to contestant who won vote
m. Apply penalty to contestant who lost vote
n. End trivia match round

Audience Vote Round
a. Receive an indication that question has been challenged
b. Output question to audience for vote
c. Receive at least one vote with that includes a wager amount
d. Tally votes to determine winner of challenge
e. Output vote result
f. Determine vote winners of audience
g. Generate and transmit reward to audience winners.

Insert Ad During Voting block out
a. Receive an indication that a challenge has been output to the audience for a vote
b. Determine appropriate ad for device viewing match
c. Output advertisement based on device for duration of vote session

Determine and Transfer Rewards based on end user activity
a. Receive activity
b. Determine reward (reward could be negative)
c. Apply reward to end user account

Challenging Contestant(s) assembled
a. Receive requests from end users to be contestants in a team trivia match
b. Receive or generate end user expertise
c. Assemble teams based on end user expertise
d. Initiate trivia session with assemble contestant teams

Contestants and Audience picked from Logged in end users
a. Receive end user log ins including requests to participate in a trivia match
b. Determine role of each logged in end user based on expertise or randomly
c. Initiate trivia session giving each end user access to the trivia match based on their determined role

Pay audience member to participate
a. Determine that an end user is an audience member
b. Generate a participation reward
c. Apply reward to end user account

Pay contestant member to participate
a. Determine that an end user is a contestant
b. Generate a participation fee
c. Apply fee to contestant account

Select Random Set of votes
a. Receive votes from audience members
b. Random select a group of votes from total votes received
c. Generate vote result from selected group of votes
d. Output vote result

Create Expert Rating for End User
a. Receive end user activity
b. Generate expertise rating based on activity
c. Store and or output expertise rating

Display Ads
a. Receive end user log in
b. Determine ads to display based on end user profile
c. Output ads

Display vote results
a. Initiate vote session
b. Receive votes
c. Output vote tallies during session
d. End vote session

Transfer Wager amounts
a. Receive a wager from an end user
b. Store wager in escrow account
c. Determine wager outcome
d. Transfer appropriate wager amount to end user based on outcome

Audience Pays to vote
a. Initiate vote session
b. Receive a vote, including a vote fee amount
c. Store vote

Select voting audience from participating audience
a. Receive a challenge of a trivia question of a trivia type
b. Generate voting audience list from participating audience based on expertise, question, and trivia type
c. Alert voting audience to vote

Adjust Vote rewards based on vote numbers
a. Receive Challenge Request
b. Output challenge for audience votes including a vote payment amount
c. Adjust vote payment amount based on votes placed

Contestant pays for votes
a. Receive a challenge request
b. Receive a vote payment amount from one or more contestants
c. Output challenge for audience votes including posting vote payment amounts offered by contestants
d. Receive vote payment amount adjustment from one or more contestants
e. Adjust posted vote payment amount
f. Receive indication that challenge time limit is reached
g. Tally votes
h. Determine vote payments due from contestant
i. Withdraw total vote payments from contestant account
j. Output payments to audience members based on posted payment amounts and votes received

Create Team
a. Receive a request to participate on a trivia team
b. Receive or determine end user expertise
c. Assemble teams based on end user requests and expertise

Create trivia match series for a team
a. Retrieve assembled teams
b. Generate trivia match series based on teams
c. Output series to each team member
d. Receive acceptance to participate in match series
e. Store match series for team

Create new trivia match for winning team
a. Determine a team winner for a trivia match
b. Generate a new trivia match time
c. Output a new trivia match time to end users participating in a team

Substitute new player if a team member does not show up for a match
a. Receive end user log in for a new trivia match
b. Determine that a team member has not logged in to play a match
c. Retrieve a list of end users logged in to participate in the match
d. Select a team member substitute
e. Insert substitute into team
f. Initiate trivia match
g. Retrieve no show penalty
h. Apply on show penalty to no show team member account
i. Retrieve substitute reward
j. Apply substitute reward to no show team member account

Provide Wikipedia Access
a. Receive an event (i.e. match, round, challenge, vote, etc) initiation
b. Determine if wikipedia is available for event
c. Determine if wikipedia is available for end user
d. Determine if wikipedia is available based on rules and conditions
e. Provide wikipedia during event

Provide Chat Access
a. Receive an event (i.e. match, round, challenge, vote, etc) initiation
b. Determine if chat is available for event
c. Determine if chat is available for end user
d. Determine if chat is available based on rules and conditions
e. Provide Chat during event

Create Compilation
a. Receive a request to create a compilation including content and type
b. Determine if end user qualifies to create compilation
c. Output content
d. Receive compilation from provided content
e. Determine if compilation meets rules and conditions
f. If compilation does not meet rules and conditions, output rules and conditions that are not met
   1. Receive an amended compilation
g. If compilation does meet rules and conditions
h. Determine fee
i. Apply fee to end user account
j. Store Compilation

Create Proof
a. Receive a request to create a proof including a type and a compilation
b. Determine if proof request meets rules and condition criteria
c. Determine and apply fee to end user account
d. Create Proof

Create Question with Compilation as Proof
a. Receive a request to create a question
b. Output available proofs
c. Receive a request to attach a proof to the question
d. Determine if proof meets rules and condition criteria
e. If proof meets rules and condition criteria, attach proof to question
f. Determine and apply fee to end user account
g. Create and store question including proof

Challenge using Proof
a. Output a question for a match
b. Receive a selected answer
c. Determine that selected answer is not the correct answer
d. Output wrong answer message
e. Receive a request to challenge the answer
f. Output proof
g. Receive a request for an audience vote
h. Receive audience vote
i. Determine winner of challenge
j. Determine and apply fees

Dispute Proof by Submitting New Proof
a. Output a question for a match
b. Receive a selected answer
c. Determine that selected answer is not the correct answer
d. Output wrong answer message
e. Receive a request to challenge the answer
f. Output proof
g. Receive a new proof
h. Output old proof and new proof to audience
i. Receive a vote about which proof is correct
j. Determine winner of challenge
k. Determine and apply fees

Select Questions based on criteria
a. Receive match data
b. Retrieve available questions based on match data and question criteria
c. Output questions to be used for match

Audience submits proof
a. Output a question for a match
b. Receive a selected answer
c. Determine that selected answer is not the correct answer
d. Output wrong answer message
e. Receive a request to challenge the answer
f. Output challenge to audience
g. Receive audience proofs
h. Output proofs
i. Receive audience vote based on entered proofs
j. Determine winner of challenge
k. Determine and apply fees

Score Question based on Compilation and or Proof
a. Receive a question
b. Score question based on rules and conditions
c. Store question with score

Audience Votes on Question
a. Output available questions for a match to audience
b. Receive audience votes for which questions to ask
c. Output questions to ask based on audience votes
d. Determine and apply fees

Determine Copyright Royalties
a. Receive video usage data
b. Determine copyright holders
c. Determine copyright royalties
d. Apply royalties to royalty pool
e. Generate royalty payments
f. Output payments to copyright holders

Skin Creation Program
a. Receive a request to create a skin including a user id, a clip id and a virtual item id
b. Determine if clip is available to create a skin
c. Determine if user id qualifies to create a skin
d. Determine if virtual item qualifies to create a skin
e. Output skin creation tool set
f. Receive skin
g. Apply skin to virtual item
h. Determine and apply fee to end user
i. Determine and apply royalty to skin copyright owner(s)

Full-scale Object Rendering from Item in Video
a. Receive a request to create a virtual item from a clip, including a clip and a virtual item type
b. Determine if virtual item is allowed to be rendered from clip
c. Determine if end user is allowed to create and or own a virtual item from the clip
d. Generate virtual item from clip
e. Store virtual item in virtual item database including clip and end user owner

Of course it will be appreciated that the systems methods described herein are provided for the purposes of example only and that none of the above systems methods should be interpreted as necessarily requiring any of the disclosed components or steps nor should they be interpreted as necessarily excluding any additional components or steps. Furthermore, it will be understood that while various embodiments are described, such embodiments should not be interpreted as being exclusive of the inclusion of other embodiments or parts of other embodiments.

The invention is described with reference to several embodiments. However, the invention is not limited to the embodiments disclosed, and those of ordinary skill in the art will recognize that the invention is readily applicable to many other diverse embodiments and applications as are reflected in the range of real world financial institutions, instruments and activities. Accordingly, the subject matter of the present disclosure includes all novel and nonobvious combinations and subcombinations of the various systems, methods configurations, embodiments, features, functions, and/or properties disclosed herein.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each claim in a set of claims has a different scope. Therefore, for example, where a limitation is explicitly recited in a dependent claim, but not explicitly recited in any claim from which the dependent claim depends (directly or indirectly), that limitation is not to be read into any claim from which the dependent claim depends.

The term “variation” of an invention means an embodiment of the invention, unless expressly specified otherwise.

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The term “consisting of” and variations thereof mean “including and limited to”, unless expressly specified otherwise.

The terms “a”, “an” and “the” mean “one or more”, unless expressly specified otherwise.

The term “plurality” means “two or more”, unless expressly specified otherwise.

The term “herein” means “in this patent application, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase “at least one of a widget, a car and a wheel” means either (i) a widget, (ii) a car, (iii) a wheel, (iv) a widget and a car, (v) a widget and a wheel, (vi) a car and a wheel, or (vii) a widget, a car and a wheel.

The phrase “based on” does not mean “based only on”, unless expressly specified otherwise. In other words, the phrase “based on” describes both “based only on” and “based at least on”.

The term “represent” and like terms are not exclusive, unless expressly specified otherwise. For example, the term “represents” does not mean “represents only”, unless expressly specified otherwise. In other words, the phrase “the data represents a credit card number” describes both “the data represents only a credit card number” and “the data represents a credit card number and the data also represents something else”.

The term “whereby” is used herein only to precede a clause or other set of words that express only the intended result, objective or consequence of something that is previously and explicitly recited. Thus, when the term “whereby” is used in a claim, the clause or other words that the term “whereby” modifies do not establish specific further limitations of the claim or otherwise restricts the meaning or scope of the claim.

The term “e.g.” and like terms means “for example”, and thus does not limit the term or phrase it explains. For example, in the sentence “the computer sends data (e.g., instructions, a data structure) over the Internet”, the term “e.g.” explains that “instructions” are an example of “data” that the computer may send over the Internet, and also explains that “a data structure” is an example of “data” that the computer may send over the Internet. However, both “instructions” and “a data structure” are merely examples of “data”, and other things besides “instructions” and “a data structure” can be “data”.

The term “determining” and grammatical variants thereof (e.g., to determine a price, determining a value, determine an object which meets a certain criterion) is used in an extremely broad sense. The term “determining” encompasses a wide variety of actions and therefore “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing, and the like. It does not imply certainty or absolute precision, and does not imply that mathematical processing, numerical methods or an algorithm process be used. Therefore “determining” can include estimating, predicting, guessing and the like.

It will be readily apparent to one of ordinary skill in the art that the various processes described herein may be implemented by, e.g., appropriately programmed general purpose computers and computing devices. Typically a processor (e.g., one or more microprocessors, one or more microcontrollers, one or more digital signal processors) will receive instructions (e.g., from a memory or like device), and execute those instructions, thereby performing one or more processes defined by those instructions.

A “processor” means one or more microprocessors, central processing units (CPUs), computing devices, microcontrollers, digital signal processors, or like devices or any combination thereof. Thus a description of a process is likewise a description of an apparatus for performing the process. The apparatus can include, e.g., a processor and those input devices and output devices that are appropriate to perform the method. Further, programs that implement such methods (as well as other types of data) may be stored and transmitted using a variety of media (e.g., computer readable media) in a number of manners. In some embodiments, hard-wired circuitry or custom hardware may be used in place of, or in combination with, some or all of the software instructions that can implement the processes of various embodiments. Thus, various combinations of hardware and software may be used instead of software only.

The term “computer-readable medium” refers to any medium that participates in providing data (e.g., instructions, data structures) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying data (e.g. sequences of instructions) to a processor. For example, data may be (i) delivered from RAM to a processor; (ii) carried over a wireless transmission medium; (iii) formatted and/or transmitted according to numerous formats, standards or protocols, such as Ethernet (or IEEE 802.3), SAP, ATP, Bluetooth™, and TCP/IP, TDMA, CDMA, and 3G; and/or (iv) encrypted to ensure privacy or prevent fraud in any of a variety of ways well known in the art.

Thus a description of a process is likewise a description of a computer-readable medium storing a program for performing the process. The computer-readable medium can store (in any appropriate format) those program elements which are appropriate to perform the method.

Just as the description of various steps in a process does not indicate that all the described steps are required, embodiments of an apparatus include a computer/computing device operable to perform some (but not necessarily all) of the described process.

Likewise, just as the description of various steps in a process does not indicate that all the described steps are required, embodiments of a computer-readable medium storing a program or data structure include a computer-readable medium storing a program that, when executed, can cause a processor to perform some (but not necessarily all) of the described process.

Where databases are described, it will be understood by one of ordinary skill in the art that (i) alternative database structures to those described may be readily employed, and (ii) other memory structures besides databases may be readily employed. Any illustrations or descriptions of any sample databases presented herein are illustrative arrangements for stored representations of information. Any number of other arrangements may be employed besides those suggested by, e.g., tables illustrated in drawings or elsewhere. Similarly, any illustrated entries of the databases represent exemplary information only; one of ordinary skill in the art will understand that the number and content of the entries can be different from those described herein. Further, despite any depiction of the databases as tables, other formats (including relational databases, object-based models and/or distributed databases) are well known and could be used to store and manipulate the data types described herein. Likewise, object methods or behaviors of a database can be used to implement various processes, such as the described herein. In addition, the databases may, in a known manner, be stored locally or remotely from any device(s) which access data in the database.

Various embodiments can be configured to work in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, or a combination of any of the above). Each of the devices may themselves comprise computers or other computing devices, such as those based on the Intel® Pentium® or Centrino™ processor, that are adapted to communicate with the computer. Any number and type of devices may be in communication with the computer.

In an embodiment, a server computer or centralized authority may not be necessary or desirable. For example, the present invention may, in an embodiment, be practiced on one or more devices without a central authority. In such an embodiment, any functions described herein as performed by the server computer or data described as stored on the server computer may instead be performed by or stored on one or more such devices.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

When a single device or article is described herein, more than one device/article (whether or not they cooperate) may alternatively be used in place of the single device/article that is described. Accordingly, the functionality that is described as being possessed by a device may alternatively be possessed by more than one device/article (whether or not they cooperate).

Similarly, where more than one device or article is described herein (whether or not they cooperate), a single device/article may alternatively be used in place of the more than one device or article that is described. For example, a plurality of computer-based devices may be substituted with a single computer-based device. Accordingly, the various functionality that is described as being possessed by more than one device or article may alternatively be possessed by a single device/article.

The functionality and/or the features of a single device that is described may be alternatively embodied by one or more other devices which are described but are not explicitly described as having such functionality/features. Thus, other embodiments need not include the described device itself, but rather can include the one or more other devices which would, in those other embodiments, have such functionality/features.

Numerous embodiments are described in this patent application, and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention(s) may be practiced with various modifications and alterations, such as structural, logical, software, and electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments of the invention nor a listing of features of the invention which must be present in all embodiments.

Neither the Title (set forth at the beginning of the first page of this patent application) nor the Abstract (set forth at the end of this patent application) is to be taken as limiting in any way as the scope of the disclosed invention(s). An Abstract has been included in this application merely because an Abstract of not more than 150 words is required under 37 C.F.R. §1.72(b).

The title of this patent application and headings of sections provided in this patent application are for convenience only, and are not to be taken as limiting the disclosure in any way.

Devices that are described as in communication with each other need not be in continuous communication with each other, unless expressly specified otherwise. On the contrary, such devices need only transmit to each other as necessary or desirable, and may actually refrain from exchanging data most of the time. For example, a machine in communication with another machine via the Internet may not transmit data to the other machine for long period of time (e.g. weeks at a time). In addition, devices that are in communication with each other may communicate directly or indirectly through one or more intermediaries.

A description of an embodiment with several components or features does not imply that all or even any of such components/features are required. On the contrary, a variety of optional components are described to illustrate the wide variety of possible embodiments of the present invention(s). Unless otherwise specified explicitly, no component/feature is essential or required.

Although process steps, algorithms or the like may be described in a sequential order, such processes may be configured to work in different orders. In other words, any sequence or order of steps that may be explicitly described does not necessarily indicate a requirement that the steps be performed in that order. On the contrary, the steps of processes described herein may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to the invention, and does not imply that the illustrated process is preferred.

Although a process may be described as including a plurality of steps, that does not imply that all or any of the steps are essential or required. Various other embodiments within the scope of the described invention(s) include other processes that omit some or all of the described steps. Unless otherwise specified explicitly, no step is essential or required.

Although a product may be described as including a plurality of components, aspects, qualities, characteristics and/or features, that does not indicate that all of the plurality are essential or required. Various other embodiments within the scope of the described invention(s) include other products that omit some or all of the described plurality.

Unless expressly specified otherwise, an enumerated list of items (which may or may not be numbered) does not imply that any or all of the items are mutually exclusive. Therefore it is possible, but not necessarily true, that something can be considered to be, or fit the definition of, two or more of the items in an enumerated list. Also, an item in the enumerated list can be a subset (a specific type of) of another item in the enumerated list. For example, the enumerated list “a computer, a laptop, a PDA” does not imply that any or all of the three items of that list are mutually exclusive—e.g., an item can be both a laptop and a computer, and a “laptop” can be a subset of (a specific type of) a “computer”.

Likewise, unless expressly specified otherwise, an enumerated list of items (which may or may not be numbered) does not imply that any or all of the items are collectively exhaustive or otherwise comprehensive of any category. For example, the enumerated list “a computer, a laptop, a PDA” does not imply that any or all of the three items of that list are comprehensive of any category.

Further, an enumerated listing of items does not imply that the items are ordered in any manner according to the order in which they are enumerated.

In a claim, a limitation of the claim which includes the phrase “means for” or the phrase “step for” means that 35 U.S.C. §112, paragraph 6, applies to that limitation.

In a claim, a limitation of the claim which does not include the phrase “means for” or the phrase “step for” means that 35 U.S.C. §112, paragraph 6 does not apply to that limitation, regardless of whether that limitation recites a function without recitation of structure, material or acts for performing that function. For example, in a claim, the mere use of the phrase “step of” or the phrase “steps of” in referring to one or more steps of the claim or of another claim does not mean that 35 U.S.C. §112, paragraph 6, applies to that step(s).

With respect to a means or a step for performing a specified function in accordance with 35 U.S.C. §112, paragraph 6, the corresponding structure, material or acts described in the specification, and equivalents thereof, may perform additional functions as well as the specified function.

Computers, processors, computing devices and like products are structures that can perform a wide variety of functions. Such products can be operable to perform a specified function by executing one or more programs, such as a program stored in a memory device of that product or in a memory device which that product accesses. Unless expressly specified otherwise, such a program need not be based on any particular algorithm, such as any particular algorithm that might be disclosed in this patent application. It is well known to one of ordinary skill in the art that a specified function may be implemented via different algorithms, and any of a number of different algorithms would be a mere design choice for carrying out the specified function.

Therefore, with respect to a means or a step for performing a specified function in accordance with 35 U.S.C. §112, paragraph 6, structure corresponding to a specified function includes any product programmed to perform the specified function. Such structure includes programmed products which perform the function, regardless of whether such product is programmed with (i) a disclosed algorithm for performing the function, (ii) an algorithm that is similar to a disclosed algorithm, or (iii) a different algorithm for performing the function.

The present disclosure provides, to one of ordinary skill in the art, an enabling description of several embodiments and/or inventions. Some of these embodiments and/or inventions may not be claimed in this patent application, but may nevertheless be claimed in one or more continuing applications that claim the benefit of priority of this patent application. Applicants intend to file additional applications to pursue patents for subject matter that has been disclosed and enabled but not claimed in this patent application.

What is claimed is:

1. A trivia game comprising:
a digital database of trivia content that is electronically accessible to a group of participants, the group of participants including one or more contestants;
a question related to the digital database, wherein the question was created by a first contestant;
at least one answer identified by the first contestant as being the answer to the question;
a participant voting mechanism whereby participants can vote on whether the answer identified by the first contestant was correct or incorrect; and
a contestant selection mechanism configured to select a participant from the group of participants to be the contestant.

2. The trivia game of claim 1 further comprising a user rating system configured to rate participants.

3. The trivia game of claim 2 wherein the user rating system is used to determine access to content in the digital database.

4. The trivia game of claim 2 wherein the user rating system is used to determine access to games.

5. The trivia game of claim 2 wherein the user rating system is used to determine access to game results.

6. The trivia game of claim 2 wherein the user rating system is used to determine eligibility to be a contestant.

7. The trivia game of claim 2 wherein the user rating system rates participants based on scores.

8. The trivia game of claim 2 wherein the user rating system rates participants based on contributions to the game.

9. The trivia game of claim 8 wherein contributions to the game comprise creation of questions.

10. The trivia game of claim 1 further comprising a series of matches, wherein each match comprises one or more questions created by one or more contestants.

11. The trivia game of claim 1 wherein the contestant selection mechanism is configured to provide a qualification survey to a user who would like to be a participant.

12. The trivia game of claim 11 wherein the user rating system rates participants based on the end user's answers to the qualification survey.

13. The trivia game of claim 11 wherein the contestant selection mechanism is configured to determine the end user's access to one or more games based on the end user's answers to the qualification survey.

14. A method comprising:
providing a digital database of trivia content that is electronically accessible to a group of participants, the group of participants;
selecting one or more of the participants to be a contestant;
allowing the contestant to create a question related to the trivia content in the digital database;
receiving an answer to the question from the contestant; and
receiving votes from the participants as to whether the answer is correct or incorrect.

15. The method of claim 14 further comprising rating the participants.

16. The method of claim 15 comprising determining a participant's access to content in the digital database based on the participant's rating.

17. The method of claim 15 comprising determining a participant's access to games based on the participant's rating.

18. The method of claim 15 comprising determining a participant's eligibility to be a contestant based on the rating.

19. The method of claim 15 comprising rating participants based on scores.

20. The method of claim 15 comprising rating participants based on contributions to the game.
